(19) United States
(12) Patent Application Publication
(10) Pub. No.: US 2014/0055259 A1
(43) Pub. Date: Feb. 27, 2014

(54) ALARMING APPARATUS, TERMINAL APPARATUS, ALARMING SYSTEM, METHOD FOR OUTPUTTING THE WARNING AND METHOD OF NOTIFICATION FOR CONVEYING A WARNING REGARDING THE RUNNING CONDITIONS OF A VEHICLE TO PEDESTRIANS

(71) Applicant: Panasonic Corporation, Osaka (JP)

(72) Inventors: Kazuoki OTANI, Kanagawa (JP); Masahisa SHIBATA, Tokyo (JP); Keiji HOSONO, Kanagawa (JP)

(73) Assignee: Panasonic Corporation, Osaka (JP)

(21) Appl. No.: 13/974,610

(22) Filed: Aug. 23, 2013

(30) Foreign Application Priority Data
Aug. 24, 2012 (JP) 2012-185144

(51) Int. Cl. B60Q 1/54

(52) U.S. Cl. CPC B60Q 1/54
USPC 340/466

(57) ABSTRACT

An alarming apparatus is mounted on a vehicle. An acquiring unit acquires the running velocity of the vehicle. A control unit detects an excess status where the traveling speed acquired by the acquiring unit exceeds a threshold value, which is higher than a speed limit stipulated for a road where the vehicle runs, for a predetermined duration of time. When the control unit has detected the excess status, an output unit outputs a warning to a pedestrian.

### BACKGROUND OF THE INVENTION

1. Field of the Invention

The present invention relates to a warning/notification technique, and it particularly relates to an alarming apparatus, a terminal apparatus, an alarming system, a method for outputting the warning, and a method of notification, for conveying a warning regarding the running conditions of a vehicle to pedestrians.

2. Description of the Related Art

A technology for preventing vehicle accidents between a vehicle and pedestrians has been proposed. A first example of such a technology is as follows. When the existence or absence of a pedestrian is detected based on an image, surrounding the vehicle, which is taken by a camera mounted on his/her own vehicle, a risk of contact with the pedestrian is computed using radar measurements. If the risk of contact therewith is high, the fact that the pedestrian is in danger will be conveyed to the pedestrian through the output of sound from a speaker or the blinking of turn indicator lamps. Assume, in a second example, that a traffic impediment monitoring system mounted on a vehicle receives a signal from a traffic impediment monitoring system carried by a pedestrian and then the vehicle's monitoring system determines the situation to be in danger. Then the traffic impediment monitoring system mounted on the vehicle outputs a warning to the traffic impediment monitoring system carried by the pedestrian.

In the first example, the image recognition processing is done and the risk of accidents is computed before the warning is outputted. In the second example, the risk of accidents is determined based on the received signal before the warning is outputted. In order to prevent the pedestrians from being involved in vehicle accidents, it is requested that the time it takes to complete the outputting of the warning be as short as possible.

### SUMMARY OF THE INVENTION

The present invention has been made in view of the foregoing circumstances, and a purpose of the invention is to provide a technology by which to reduce the time period before the outputting of a warning to a pedestrian.

In order to resolve the above-described problems, an alarming apparatus according to one embodiment of the present invention is an alarming apparatus mountable on a vehicle, and the alarming apparatus include: an acquiring unit configured to acquire a running velocity of the vehicle; a control unit configured to detect an excess status where the running velocity acquired by the acquiring unit exceeds a threshold value, which is higher than a speed limit set for a road on which the vehicle runs, for a predetermined duration of time; and an output unit configured to output a warning to a pedestrian, when the control unit has detected the excess status.

Another embodiment of the present invention relates to a terminal apparatus. The terminal apparatus, which is carriable by a pedestrian, includes: a receiver configured to receive a radio signal, which is transmitted from an alarming apparatus mountable on a vehicle, when a running velocity of the vehicle exceeds a threshold value, which is higher than a speed limit set for a road on which the vehicle runs, for a predetermined duration of time; and a notification unit configured to convey a warning to a pedestrian, when the receiver has received the radio signal.

Still another embodiment of the present invention relates to an alarming apparatus. The alarming system is an alarming apparatus in an alarming system that includes an alarming apparatus mountable on a vehicle and a terminal apparatus carriable by a pedestrian, and the alarming apparatus includes: an acquiring unit configured to acquire a running velocity of the vehicle; a control unit configured to detect an excess status where the running velocity acquired by the acquiring unit exceeds a threshold value, which is higher than a speed limit set for a road on which the vehicle runs, for a predetermined duration of time; and an output unit configured to transmit a radio signal, when the control unit has detected the excess status.

Still another embodiment of the present invention relates to a terminal apparatus. The terminal apparatus is a terminal apparatus in an alarming system that includes an alarming apparatus mountable on a vehicle and a terminal apparatus carriable by a pedestrian, and the terminal apparatus includes: a receiver configured to receive a radio signal, which is transmitted from the alarming apparatus, when a running velocity of the vehicle exceeds a threshold value, which is higher than a speed limit set for a road on which the vehicle runs, for a predetermined duration of time; and a notification unit configured to convey a warning to a pedestrian, when the receiver has received the radio signal.

Still another embodiment of the present invention relates to an alarming system. The alarming system includes: an alarming apparatus mountable on a vehicle; and a terminal apparatus carriable by a pedestrian. When a running velocity of the vehicle exceeds a threshold value, which is higher than a speed limit set for a road on which the vehicle runs, for a predetermined duration of time, the alarming apparatus transmits a radio signal. When the terminal apparatus receives the radio signal from the alarming apparatus, the terminal apparatus conveys a warning to a pedestrian.

Still another embodiment of the present invention relates to a method for outputting a warning. The method is a method for outputting a warning in an alarming apparatus mountable on a vehicle, and the method includes: acquiring a running velocity of the vehicle; detecting an excess status where the running velocity acquired exceeds a threshold value, which is higher than a speed limit set for a road on which the vehicle runs, for a predetermined duration of time; and outputting a warning to a pedestrian, when the excess status is detected.

Still another embodiment of the present invention relates to a method of notification. The method is a method of notification in a terminal apparatus carriable by a pedestrian, and the method includes: receiving a radio signal, which is transmitted from an alarming apparatus mountable on a vehicle, when a running velocity of the vehicle exceeds a threshold value, which is higher than a speed limit set for a road on which the vehicle runs, for a predetermined duration of time; and conveying a warning to the pedestrian, when the radio signal is received.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a structure of an alarming system according to a first exemplary embodiment of the present invention;

FIG. 2 shows a structure of an alarming apparatus shown in FIG. 1;

FIG. 3 shows a data structure of a table stored in a comparison unit shown in FIG. 2;

FIG. 4 shows a structure of a terminal apparatus shown in FIG. 1;

FIG. 5 shows an output procedure implemented by an alarming apparatus shown in FIG. 2;

FIG. 6 is a flowchart showing a procedure in which the terminal apparatus of FIG. 4 sends a notification;

FIG. 7 shows a structure of an alarming apparatus according to a second exemplary embodiment of the present invention;

FIG. 8 shows a data structure of a table stored in a threshold setting unit shown in FIG. 7;

FIG. 9 is a flowchart showing a procedure in which a threshold value is adjusted by the alarming apparatus of FIG. 7;

FIG. 10 is a flowchart showing a procedure in which an output is adjusted by the alarming apparatus of FIG. 7;

FIG. 11 shows a structure of an alarming apparatus according to a third exemplary embodiment of the present invention;

FIG. 12 shows a data structure of a table stored in a threshold setting unit shown in FIG. 11;

FIG. 13 is a flowchart showing a procedure in which a threshold value is adjusted by the alarming apparatus of FIG. 11;

FIG. 14 is a flowchart showing a procedure in which an output is adjusted by the alarming apparatus of FIG. 11;

FIG. 15 shows a structure of an alarming apparatus according to a fourth exemplary embodiment of the present invention;

FIG. 16 shows a data structure of a table stored in a threshold setting unit shown in FIG. 15;

FIG. 17 is a flowchart showing a procedure in which a threshold value is adjusted by the alarming apparatus of FIG. 15;

FIG. 18 shows a data structure of a table stored in a comparison unit in a fifth exemplary embodiment of the present invention; and

FIG. 19 is a flowchart showing that a certain period of time is adjusted by an alarming apparatus according to a fifth exemplary embodiment of the present invention.

### DETAILED DESCRIPTION OF THE INVENTION

The invention will now be described by reference to the preferred embodiments. This does not intend to limit the scope of the present invention, but to exemplify the invention.

### First Exemplary Embodiment

The present invention will be outlined before it is explained in detail. A first exemplary embodiment of the present invention relates to an alarming system where radio signals are transmitted from an alarming apparatus mounted on an automobile or the like to terminal apparatuses carried by pedestrians. If a vehicle travels, at speed exceeding a speed limit stipulated on a road by at least a predetermined excess speed, for at least a predetermined length of time (hereinafter referred to as “excess status” also), pedestrians will be at increased risk. As the excess status is detected, the alarming apparatus makes a large volume of sound through a speaker mounted on the exterior of the vehicle and/or blinks headlamps. Thereby, the alarming apparatus informs the surrounding pedestrians of a possibly imminent danger. In order to also inform a pedestrian, whose field of view does not cover the vehicle at all (namely, the vehicle is out of his/her sight), about the danger, the alarming apparatus transmits radio signals. As the terminal apparatuses carried by pedestrians receive the radio signals, the danger is conveyed to the pedestrians.

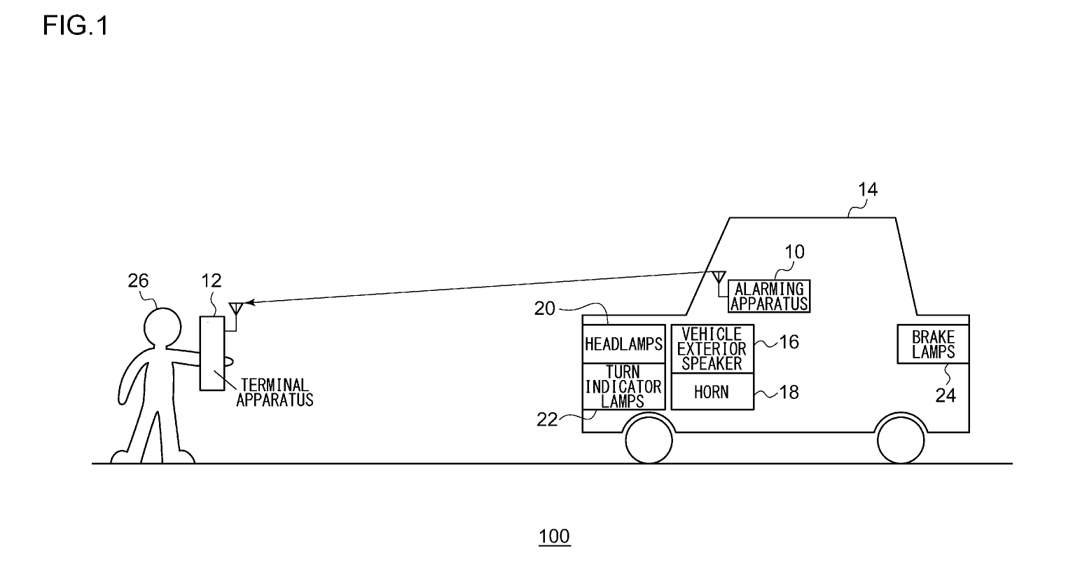

FIG. 1 shows a structure of an alarming system 100 according to a first exemplary embodiment of the present invention. The alarming system 100 includes an alarming apparatus 10 mounted on a vehicle 14, a vehicle exterior speaker 16, a horn 18, headlamps 20, turn indicator lamps 22, brake lamps 24, and a terminal apparatus 12 carried by a pedestrian 26.

The alarming apparatus 10 is included in a navigation apparatus mounted on the vehicle 14, for instance. The alarming apparatus 10 monitors whether the vehicle is in the aforementioned excess status or not. If the vehicle is in an excess status, the alarming apparatus 10 will convey a warning to the pedestrian 26 from the vehicle exterior speaker 16 via the brake lamps 24. Further, alarming apparatus 10 transmits radio signals when the excess status is detected. The detection of the excess status by the alarming apparatus 10, the notification of warning from the vehicle exterior speaker 16 via the brake lamps 24, and the notification of warning through the radio signals will be discussed later.

The terminal apparatus 12 is included inside a wristwatch worn by the pedestrian 26 or a mobile phone device carried by the pedestrian 26, for instance. The terminal apparatus 12 may be carried by the pedestrian as a single and separate unit. If the terminal apparatus 12 receives the radio signals sent from the alarming apparatus 10, the terminal apparatus 12 will convey a warning to the pedestrian 26. The notification of warning by the terminal apparatus 12 will be discussed later. When the pedestrian 26 is notified of the warning, he/she recognizes the presence of a vehicle 14 that is in the excess state.

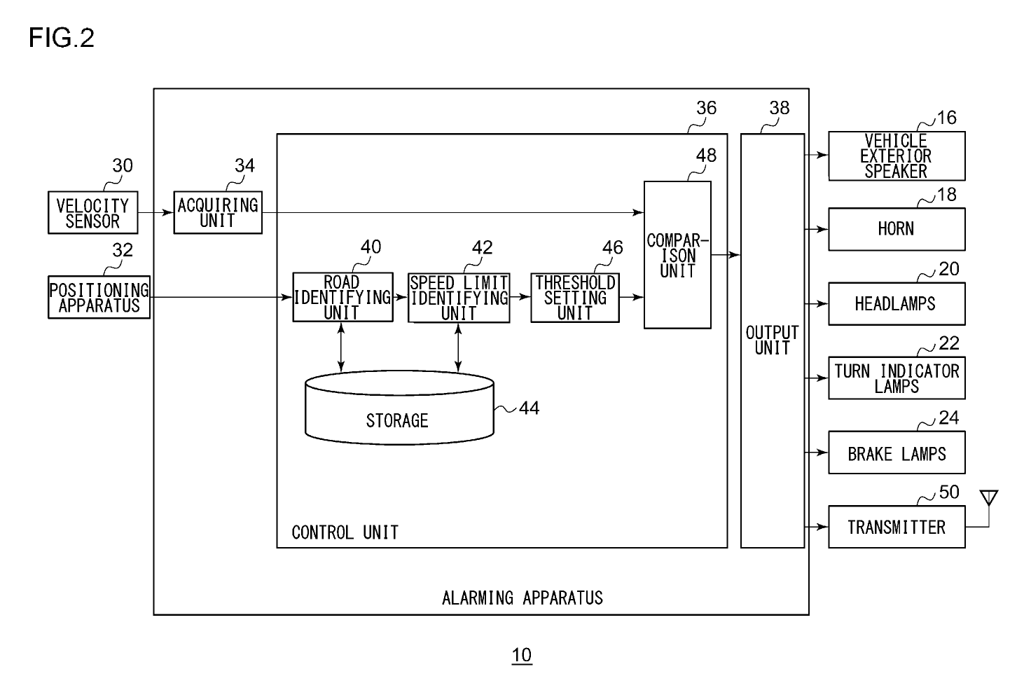

FIG. 2 shows a structure of the alarming apparatus 10. The alarming apparatus 10 includes an acquiring unit 34, a control unit 36, and an output unit 38. The control unit 36 includes a road identifying unit 40, a speed limit identifying unit 42, a storage 44, a threshold setting unit 46, and a comparison unit 48. Connected to the alarming apparatus 10 are a velocity sensor 30, a positioning apparatus 32, a vehicle exterior speaker 16, a horn 18, headlamps 20, turn indicator lamps 22, brake lamps 24, and a transmitter 50. The velocity sensor 30 measures the running velocity of the not-shown vehicle 14. Known art may be used to measure the running velocity and therefore the description of the velocity sensor 30 is omitted here. The velocity sensor 30 outputs the running velocity, which has been measured thereby, to the acquiring unit 34. The acquiring unit 34 acquires the running velocity of the vehicle 14 from the velocity sensor 30. The acquiring unit 34 outputs the running velocity to the control unit 36.

The positioning apparatus 32, which is mounted on the vehicle 14, measures positional information by use of a global positioning system (GPS), a vehicle pulse detection, a gyro sensor or the like. The positional information is indicated by the latitude and longitude, and this corresponds to the positional information on the vehicle 14. If no velocity sensor 30 is mounted on the vehicle 14, the running velocity may be measured by the positioning apparatus 32. The positioning apparatus 32 outputs the positional information to the road identifying unit 40.

The road identifying unit 40 receives the positional information on the vehicle 14 from the positioning apparatus 32. Note here that road information is stored in the storage 44. The routes of roads in the road information are indicated by longitudes and latitudes. Further, the road information includes information regarding intersections on roads, information regarding the widths of roads, information regarding the speed limits set for the roads, and so forth. The road identifying unit 40 references the road information stored in the storage 44 and thereby identifies a road representing or containing the positional information received from the positioning apparatus 32. The road identified thereby corresponds to the road on which the road identifying unit 40 is traveling.

The road identifying unit 40 informs the speed limit identifying unit 42 of the thus identified road. The speed limit identifying unit 42 references the road information stored in the storage 44 and thereby identifies a regulated speed limit for the road identified by the road identifying unit 40. The speed limit identifying unit 42 informs the threshold setting unit 46 of the thus identified speed limit. The threshold setting unit 46 receives the speed limit from the speed limit identifying unit 42. The threshold setting unit 46 adds a preset value to the speed limit so as to generate a threshold value. The “preset value” is predefined as 10 km/h, for instance. The threshold setting unit 46 may also generate a threshold value by multiplying the speed limit by a predetermined factor. Here, the “predetermined factor” may be a value greater than “1” and is predefined as the factor of 1.2, for instance. Thus, the threshold value is set to a value greater than the speed limit. The threshold setting unit 46 sets a threshold value for the comparison unit 48.

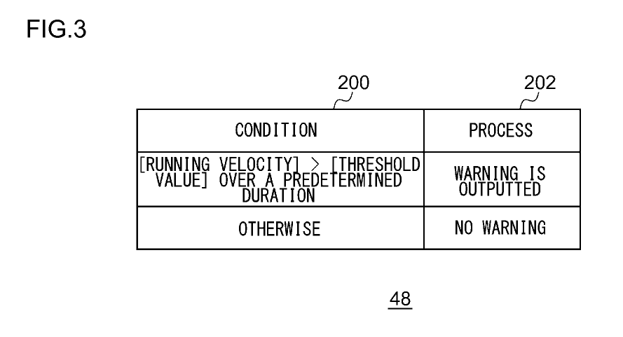

The comparison unit 48 receives the running velocity from the acquiring unit 34. At the same time, a threshold value is set by the threshold setting unit 46. The comparison unit 48 compares the running velocity against the threshold value. The comparison unit 48 detects an excess status if the running velocity exceeds the threshold value over a certain period of time. The “certain period of time” may be predefined as five seconds, for instance. If the excess status is detected, the comparison unit 48 will determine the output of a warning. FIG. 3 shows a data structure of a table stored in the comparison unit 48. As shown in FIG. 3, a condition column 200 and a process column 202 are contained in the table. If the running velocity is greater than a threshold value over a certain period of time (if [running velocity]>[threshold value] for a certain period of time), the comparison unit 48 will determine the output of a warning as the excess state. If otherwise, no warning will be outputted. Now, refer back to FIG. 2. If the output of the warning has been determined, the comparison unit 48 will instruct the output unit 38 to output the warning.

If the output unit 38 is instructed to output the warning from the comparison unit 48, the output unit 38 will output the warning to the pedestrian 26 using the transmitter 50 from the vehicle exterior speaker 16. The vehicle exterior speaker 16 is a speaker used to output sounds to the exterior of the vehicle 14. The output unit 38 outputs a warning sound from the vehicle exterior speaker 16 as the output of a warning. The horn 18 corresponds to a car horn. The output unit 38 causes the horn 18 to output sounds as the output of the warning. The headlamp 20 is a lamp used to illuminate an area in front of the vehicle 14. The turn indicator lamp 22 is a lamp used to convey a right or left turn of the vehicle 14 to other vehicles or pedestrians around the vehicle 14. The brake lamp 24 is a lamp used to convey to other vehicles or the pedestrians around the vehicle 14 the fact that a brake pedal has been stepped on by the driver of the vehicle 14. The output unit 38 has these lamps light up or blink as the output of the warning.

The transmitter 50 is an apparatus capable of transmitting radio signals. Though a radio communication system for transmitting the radio signals may be an arbitrary one, a radio communication system requiring no association with a not-shown receiving apparatus may be suitable. Note that the radio communication system may be a mobile phone communication system. It is assumed herein that the former is used. Then the output unit 38 has the transmitter 50 transmit the radio signals as the output of the warning. Here, the destination of radio signals is not specified and therefore the mode of transmission corresponds to the transmission by broadcast.

It is to be noted here that all of the vehicle exterior speaker 16, the horn 18, the headlamp 20, the turn indicator lamp 22, the brake lamp 24, and the transmitter 50 may not be used and, instead, at least one of them may be used. The transmission of radio signals from the transmitter 50 is effective in that the pedestrian 26, who otherwise cannot recognize the presence of the vehicle 14 through sound or light, can be aware of the warning. If no transmitter 50 is available, the pedestrian 26 does not have to carry the terminal apparatus 12 with himself/herself.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

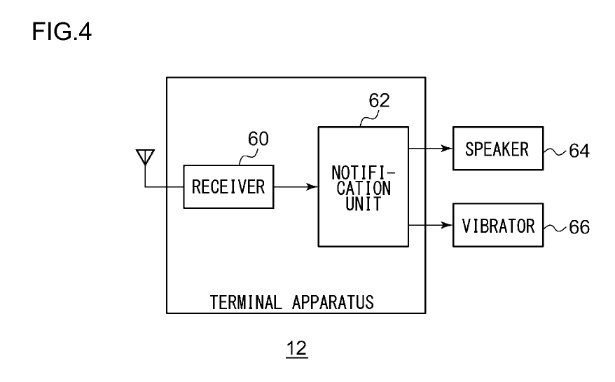

FIG. 4 shows a structure of the terminal apparatus 12. The terminal apparatus 12 includes a receiver 60 and a notification unit 62. A speaker 64 and a vibrator 66 are connected to the terminal apparatus 12. The receiver 60 is compatible with a radio communication system used for the transmitter 50 in the alarming apparatus 10, and receives the radio signals from the transmitter 50. These radio signals are radio signals sent from the alarming apparatus 10 mountable on the vehicle 14, and receiving these radio signals corresponds to receiving the radio signals in the excess state. Upon receipt of the radio signals, the receiver 60 outputs to the notification unit 62 the fact that the radiation signals have been received.

When the receiver 60 receives such radio signals, the notification unit 62 conveys the warning to the pedestrian 26. Here, the warning is conveyed thereto by outputting an audible warning sound from the speaker 64 and vibrating the vibrator 66, for instance. Note that either the warning sound or vibration may be outputted. Also, the notification unit 62 may convey the warning thereto by lighting up a display provided in the wristwatch and mobile phone device that includes the terminal apparatus 12 therein.

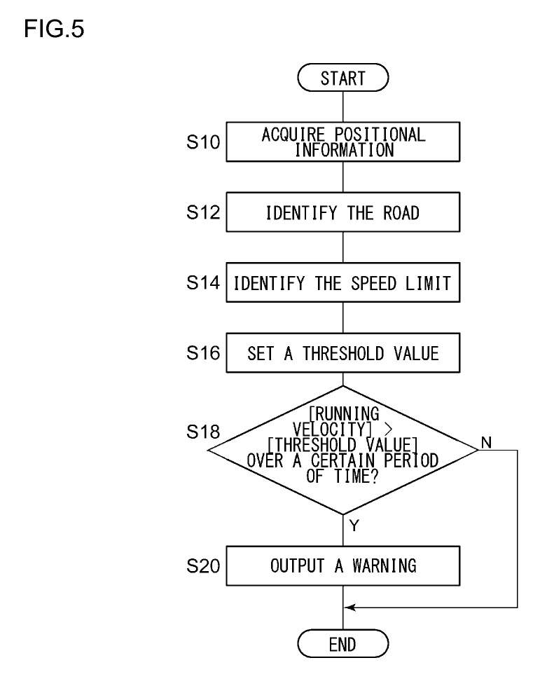

An operation of the alarming system 100 as configured above is now described. FIG. 5 shows an output procedure implemented by the alarming apparatus 10. The positioning apparatus 32 acquires positional information (S10). The road identifying unit 40 identifies a road (S12). The speed limit identifying unit 42 identifies a speed limit (S14). The threshold setting unit 46 sets a threshold value (S16). If the comparison unit 48 detects that the running velocity is greater than the threshold value over a certain period of time (Y of S18), the output unit 38 will output a warning (S20). If the comparison unit 48 does not detect that [running velocity]>[threshold value] for a certain period of time (N of S18), Step S20 will be skipped.

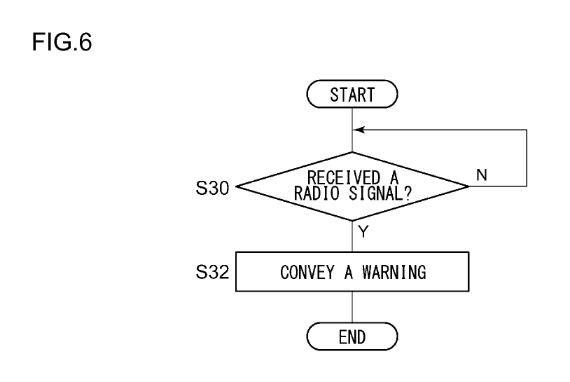

FIG. 6 is a flowchart showing a procedure in which the terminal apparatus 12 sends a notification. If the receiver 60 does not receive the radio signals (N of S30), the terminal apparatus 12 will stand ready. If the receiver 60 receives the radio signal (Y of S30), the notification unit 62 will convey a warning (S32).

By employing the first exemplary embodiment, the warning is outputted to the pedestrians when the excess status, where the running velocity exceeds a threshold value greater than the speed limit for a certain duration of time, is detected. Thus, the warning can be outputted immediately after the excess status is detected. Since the warning is outputted immediately, the excess status can be instantly informed to the pedestrians. Also, since the excess status is detected after a certain time period has elapsed, the output of unnecessary warnings can be suppressed. Also, since audible sound is outputted as the warning, the waning can alert pedestrians near the vehicle. Also, since the warning is outputted using the medium of light beams, the warning can alert the pedestrians. Also, since the warning is outputted using the radio signals, the warning can also alert those pedestrians who are in a position where no sound or light can reach or in a position far from the vehicle. In other words, the warning can be outputted, in a short time, to the pedestrians near the vehicle as well as the pedestrians far from the vehicle. Also, since the terminal apparatus does not have to be provided with a transmitter, the configuration of the terminal apparatus can be made simpler. Also, since the apparatus configuration is simplified, the overall cost can be reduced. Also, the processing carried out by the terminal apparatus is made simpler, the power consumed by the terminal apparatus can be reduced.

### Second Exemplary Embodiment

Similar to the first exemplary embodiment, a second exemplary embodiment of the present invention relates also to an alarming system. In the first exemplary embodiment, the same threshold value is set for the same road. In contrast thereto, there are cases where it is suitable that mutually different threshold values be set for the same road. For example, local residents who are asleep need to be taken into consideration when the vehicle travels along a road near a residential area at night. In order to cope with this, in the second exemplary embodiment the threshold value at night is set higher than the threshold value during the daytime. Thus the excess status will be less likely to be detected. As a result, the audible sound as the warning will be less likely to be outputted. An alarming system 100 and a terminal apparatus 12 according to the second exemplary embodiment are of similar type to those shown in FIG. 1 and FIG. 4, respectively. A description is given hereunder centering around features different from the first exemplary embodiment.

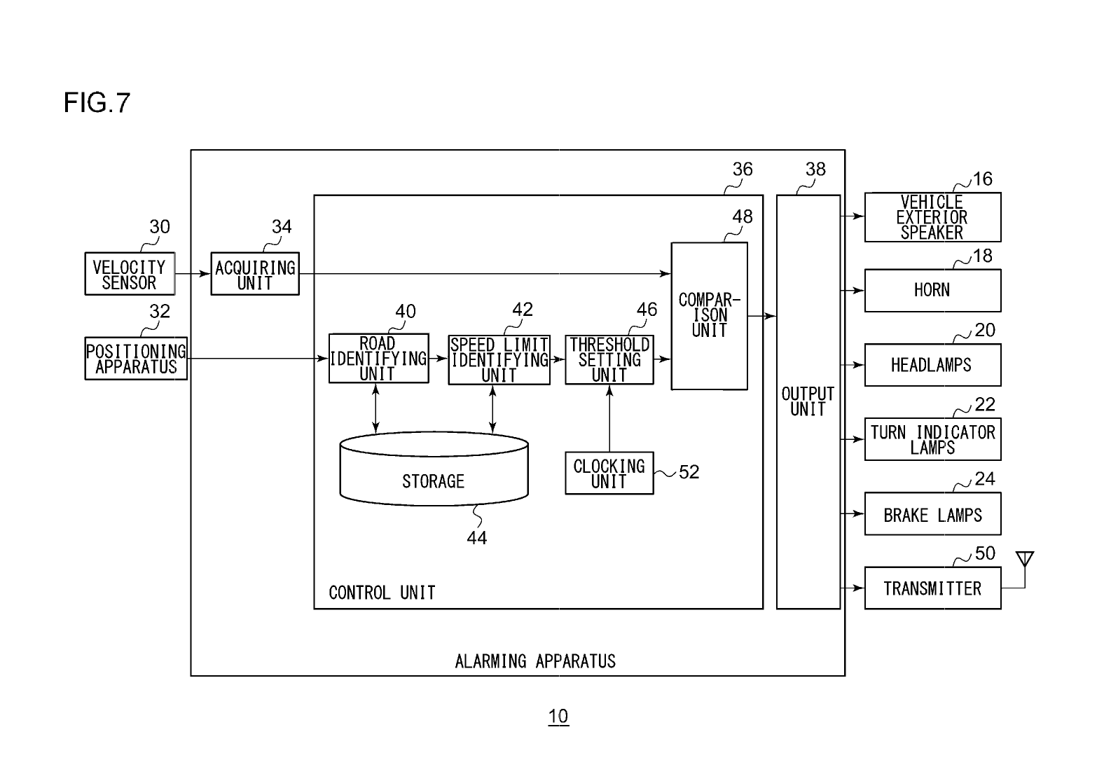

FIG. 7 shows a structure of an alarming apparatus 10 according to the second exemplary embodiment of the present invention. Compared with FIG. 2, the control unit 36 further includes a clocking unit 52. The clocking unit 52 counts time. The clocking unit 52 outputs the time to the threshold setting unit 46. As described earlier, the threshold setting unit 46 temporarily generates a threshold value based on the speed limit. Also, the threshold setting unit 46 receives the time from the clocking unit 52. The threshold setting unit 46 varies the threshold value according to the time of day. A concrete process for varying the threshold value will be described hereinbelow.

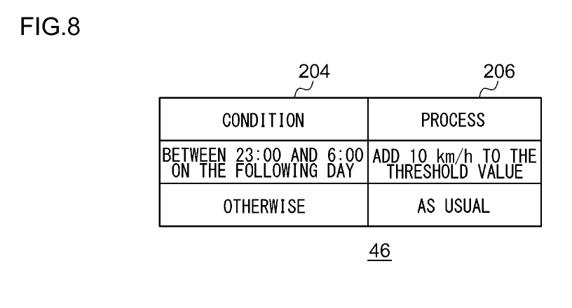

FIG. 8 shows a data structure of a table stored in the threshold setting unit 46. As shown in FIG. 8, a condition column 204 and a process column 206 are contained in the table. If the time is between 23:00 and 6:00 on the following day, the threshold setting unit 46 will add 10 km/h to the temporarily generated threshold value so as to generate again a threshold value. Here, the value to be added is not limited to 10 km/h. If the time is not between 23:00 and 6:00 on the following day, the threshold value will not be changed. With such a processing as described above, the threshold setting unit 46 sets a threshold value, which is greater than that used in the other times during the daytime, during the time zone between 23:00 and 6:00 on the following day. Now, refer back to FIG. 7.

The output unit 38 varies the volume of sound, the light intensity and the transmission power according to the threshold value. When, for example, a warning is outputted as the output of sounds from the vehicle exterior speaker 16 and the horn 18, the output unit 38 lowers the volume of sound as the threshold value gets larger. Also, when the warning is outputted as the output of lights from the headlamps 20, the turn indicator lamps 22 and the brake lamps 24, the output unit 38 increases the light intensity as the threshold value gets larger. Further, when the warning is outputted as the output of radio signals from the transmitter 50, the output unit 38 increases the transmission power as the threshold value gets larger. These processes correspond to the increase in the light intensity and the increase in the transmission power at night between 23:00 and 6:00 on the following day although the volume of sound is lowered during these night hours.

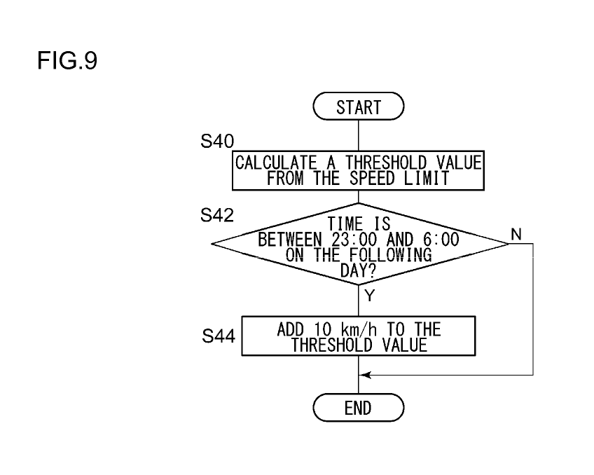

An operation of the alarming system 100 as configured above is now described. FIG. 9 is a flowchart showing a procedure in which the threshold value is adjusted by the alarming apparatus 10. This procedure corresponds to Step S16 of FIG. 5. The threshold setting unit 46 calculates a threshold value from the speed limit (S40). If time is between 23:00 and 6:00 on the following day (Y of S42), the speed limit identifying unit 42 will add 10 km/h to the threshold value (S44). If time is not between 23:00 and 6:00 on the following day (N of S42), Step S44 will be skipped.

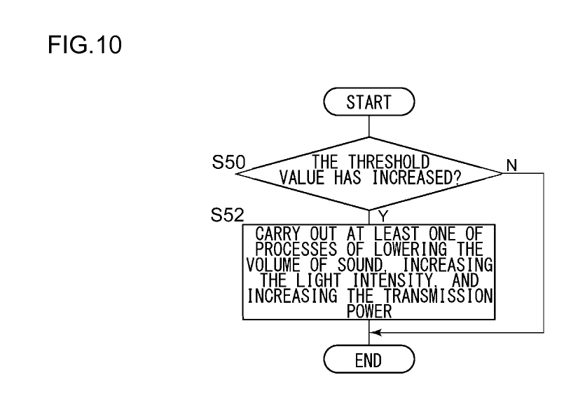

FIG. 10 is a flowchart showing a procedure in which the output is adjusted by the alarming apparatus 10. If the threshold setting unit 46 has increased the threshold value (Y of S50), the output unit 38 will carry out at least one of processes of lowering the volume of sound, increasing the light intensity and increasing the transmission power (S52). If the threshold setting unit 46 does not increase the threshold value (N of S50), Step S52 will be skipped.

By employing the second exemplary embodiment, the threshold value is varied according to the time of day. Thus the frequency at which the warning is outputted can be so adjusted as to suit the actual time zone. Also, since the threshold value is raised at night, the sound can be less likely to be outputted. Also, since the sound is less likely to be outputted, the effect of sound on the surrounding local residents can be reduced. Also, as the threshold value increases, the volume of sound is lowered. Thus the effect of sound on the surrounding local residents can be reduced. Also, as the threshold value increases, the light intensity or the transmission power is increased, so that the pedestrians can be alerted while the effect of sound on the surrounding local residents is reduced.

### Third Exemplary Embodiment

Similar to the first and second exemplary embodiments, a third exemplary embodiment of the present invention relates also to an alarming system. In the second exemplary embodiment, the threshold value is varied according to the time of day. In contrast thereto, there are cases where it is suitable that a different threshold value, which differs from the threshold value for other parts of a given road, may be set for only a specific part of the road. Assume, for example, that a part of a road is designated as a street for students going to and from school (this street or road will be hereinafter referred to as “school route” also). Then the number of students, who walk on this specific part of the road during the students' commuting hours, increases. In order to cope with this, in the third exemplary embodiment the threshold value for the specific part designated as the school route in a road is set lower than the threshold value for the other parts of the road. Thus the excess status will be more likely to be detected. As a result, the warning will be more likely to be outputted. An alarming system 100 and a terminal apparatus 12 according to the third exemplary embodiment are of similar type to those shown in FIG. 1 and FIG. 4, respectively. A description is given hereunder centering around features different from the previous exemplary embodiments.

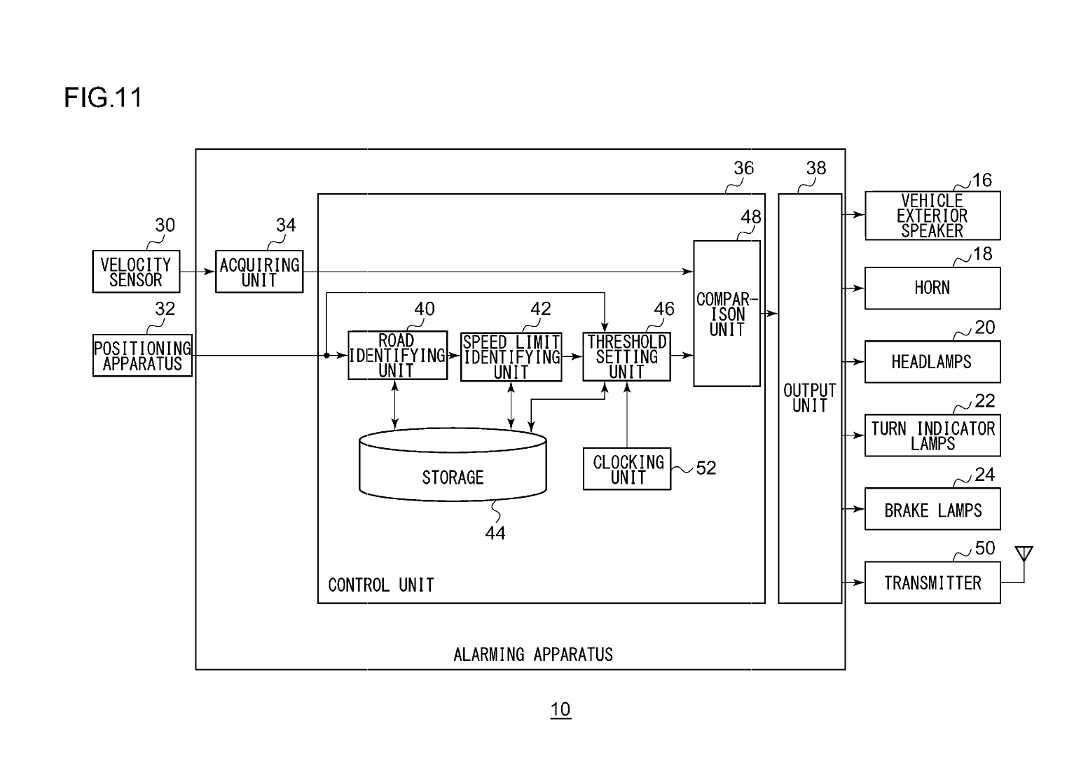

FIG. 11 shows a structure of an alarming apparatus 10 according to the third exemplary embodiment of the present invention. Compared with FIG. 7, the alarming apparatus 10 is comprised of the similar structural components. What differs from the alarming apparatus 10 as shown in FIG. 7 is that, in the alarming apparatus 10 of FIG. 11, the threshold setting unit 46 is connected to the storage 44. The road information stored in the storage 44 also contains information regarding the school routes. Upon receipt of the positional information, the threshold setting unit 46 references the road information stored in the storage 44 so as to identify whether the positional information is contained in the school routes or not. The threshold setting unit 46 receives the time from the clocking unit 52 and verifies whether the received time is included in the commuting hours or not. The commuting hours are defined to be between 7:00 and 8:30, for instance. If the positional information is contained in the school routes and the commuting hours, the threshold setting unit 46 will change the threshold value. In this manner, the threshold setting unit 46 varies the threshold value according to an area that contains the road on which the vehicle 14 travels.

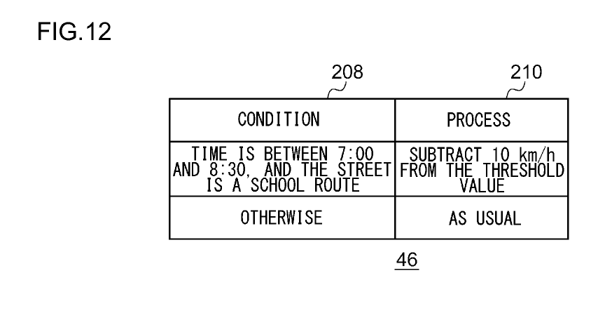

A concrete process for varying the threshold value will be described hereinbelow. FIG. 12 shows a data structure of a table stored in the threshold setting unit 46. As shown in FIG. 12, a condition column 208 and a process column 210 are contained in the table. If the time is between 7:00 and 8:30, the threshold setting unit 46 will subtract 10 km/h from the temporarily generated threshold value so as to generate again a threshold value. Here, the value to be subtracted is not limited to 10 km/h. If the time is not between 7:00 and 8:30, the threshold value will not be changed. By performing such a processing as described above, when the road is included in the school routes and the time is included in the commuting hours, the threshold setting unit 46 sets a threshold value that is less than when otherwise. Now, refer back to FIG. 11.

When, for example, a warning is outputted as the output of sounds from the vehicle exterior speaker 16 and the horn 18, the output unit 38 increases the volume of sound as the threshold value gets smaller. Also, when the warning is outputted as the output of lights from the headlamps 20, the turn indicator lamps 22 and the brake lamps 24, the output unit 38 increases the light intensity as the threshold value gets smaller. Further, when the warning is outputted as the output of radio signals from the transmitter 50, the output unit 38 increases the transmission power as the threshold value gets smaller. These processes correspond to the increase in the volume of sound, the increase in the light intensity and the increase in the transmission power when the road is included in the school routes and the time is included in the commuting hours.

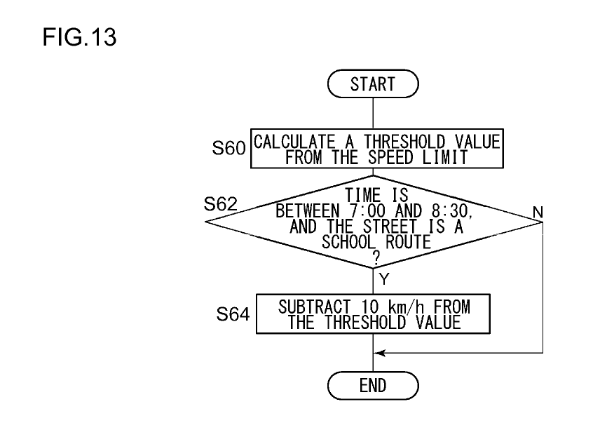

FIG. 13 is a flowchart showing a procedure in which the threshold value is adjusted by the alarming apparatus 10. This procedure corresponds to Step S16 of FIG. 5. The threshold setting unit 46 calculates a threshold value from the speed limit (S60). If time is between 7:00 and 8:30 and if the street is a school route (Y of S62), the speed limit identifying unit 42 will subtract 10 km/h from the threshold value (S64). If time is not between 7:00 and 8:30 or if the street is not a school route (Y of S62), Step S64 will be skipped.

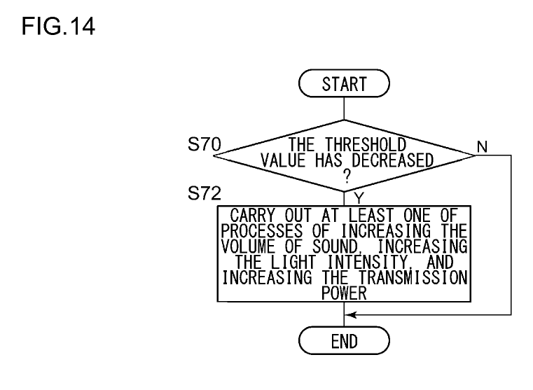

FIG. 14 is a flowchart showing a procedure in which the output is adjusted by the alarming apparatus 10. If the threshold setting unit 46 has decreased the threshold value (Y of S70), the output unit 38 will carry out at least one of processes of increasing the volume of sound, increasing the light intensity and increasing the transmission power (S72). If the threshold setting unit 46 does not decrease the threshold value (N of S70), Step S72 will be skipped.

By employing the third exemplary embodiment, the threshold value is varied according to an area. Thus the frequency at which the warning is outputted can be so adjusted as to suit a partial area of the road. Also, since the threshold value is lowered if the partial area thereof belongs to any school routes, the sound can be more likely to be outputted. Also, since the sound is more likely to be outputted, the students can be more likely to be alerted. Also, as the threshold value drops, at least one of the sound, the light intensity and the transmission power is raised, so that the pedestrians can be alerted.

### Fourth Exemplary Embodiment

Similar to the first to third exemplary embodiments, a fourth exemplary embodiment of the present invention relates also to an alarming system. In the second or third exemplary embodiment, the threshold value is varied according to the time of day or an area. In contrast thereto, there are cases where it is suitable that a different threshold value, which differs from the threshold value used when it is not raining, may be set if it is raining. For example, if it is raining, the field of view of a driver degrades as compared to when the weather is fine. In order to cope with this, in the fourth exemplary embodiment the threshold value used when it is raining is set lower than the threshold value used when otherwise. Thus the excess status will be more likely to be detected. As a result, the warning will be more likely to be outputted. An alarming system 100 and a terminal apparatus 12 according to the fourth exemplary embodiment are of similar type to those shown in FIG. 1 and FIG. 4, respectively. A description is given hereunder centering around features different from the previous exemplary embodiments.

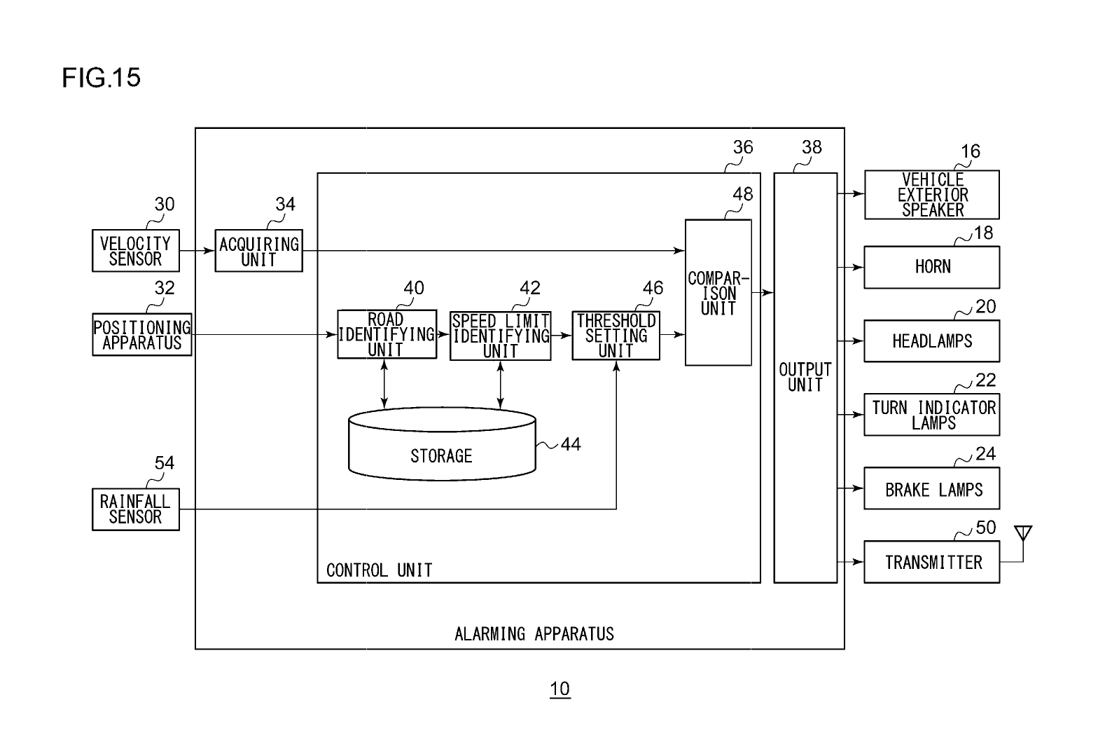

FIG. 15 shows a structure of an alarming apparatus 10 according to the fourth exemplary embodiment of the present invention. Compared with FIG. 2, the alarming apparatus 10 is comprised of the similar structural components. What differs from the alarming apparatus 10 as shown in FIG. 2 is that, in the alarming apparatus 10 of FIG. 15, a rainfall sensor 54 is connected to the alarming apparatus 10. The rainfall sensor 54 is a sensor used to detect whether it is raining or not. Known art may be used to detect if it is raining, and therefore the description of the rainfall sensor 54 is omitted here. When the rainfall sensor 54 detects that it is raining, the rainfall sensor 54 informs the control unit 36 accordingly.

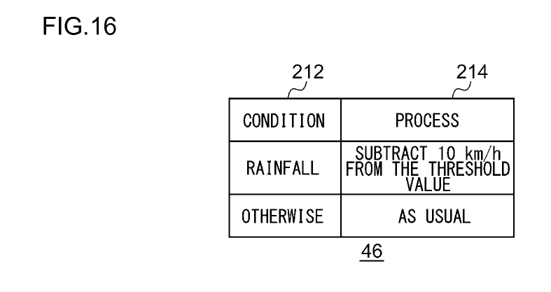

If the rainfall sensor 54 conveys to the threshold setting unit 46 that rain has been detected, the threshold setting unit 46 will change the threshold value. In this manner, the threshold setting unit 46 varies the threshold value according to the weather. A concrete process for varying the threshold value will be described hereinbelow. FIG. 16 shows a data structure of a table stored in the threshold setting unit 46. As shown in FIG. 16, a condition column 212 and a process column 214 are contained in the table. If it is raining, the threshold setting unit 46 will subtract 10 km/h from the temporarily generated threshold value so as to generate again a threshold value. Here, the value to be subtracted is not limited to 10 km/h. If it is not raining, the threshold value will not be changed. By performing such a processing as described above, when it is raining, the threshold setting unit 46 sets a threshold value that is less than when otherwise. Now, refer back to FIG. 15.

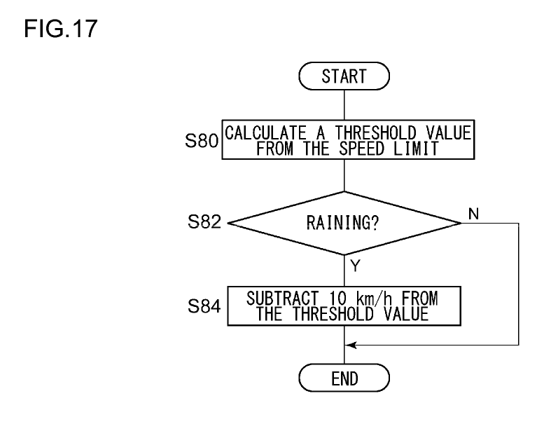

FIG. 17 is a flowchart showing a procedure in which the threshold value is adjusted by the alarming apparatus 10. This procedure corresponds to Step S16 of FIG. 5. The threshold setting unit 46 calculates a threshold value from the speed limit (S80). If it is detected that the weather is raining (Y of S82), the speed limit identifying unit 42 will subtract 10 km/h from the threshold value (S84). If no rain is detected (N of S82), Step 84 will be skipped.

By employing the fourth exemplary embodiment, the threshold value is varied according to the weather. Thus the frequency at which the warning is outputted can be so adjusted as to suit the weather. Also, since the threshold value is lowered if it is raining, the sound can be more likely to be outputted. Also, since the sound is more likely to be outputted, the pedestrians whose field of view is poor can be more likely to be alerted. Also, as the threshold value drops, at least one of the sound, the light intensity and the transmission power is raised, so that the pedestrians can be alerted.

### Fifth Exemplary Embodiment

Similar to the first to fourth exemplary embodiments, a fifth exemplary embodiment of the present invention relates also to an alarming system. In the previous exemplary embodiments, a certain period of time is fixed. There are cases where it is suitable that such a preset period of time may be varied. For example, as the running velocity becomes higher, a pedestrian may be at a higher risk of being hit or the like by a vehicle. Thus, it is suitable that a period until when the warning is outputted be reduced. In order to cope with this, in the fifth exemplary embodiment the certain period of time is shortened as the running velocity becomes higher. As a result, the warning will be more likely to be outputted. An alarming system 100 and a terminal apparatus 12 according to the fifth exemplary embodiment are of similar type to those shown in FIG. 1 and FIG. 4, respectively. An alarming apparatus 10 according to the fifth exemplary embodiment is of similar type to any one of those shown in FIG. 2, FIG. 7, FIG. 11, and FIG. 15. A description is given hereunder centering around features different from the previous exemplary embodiments.

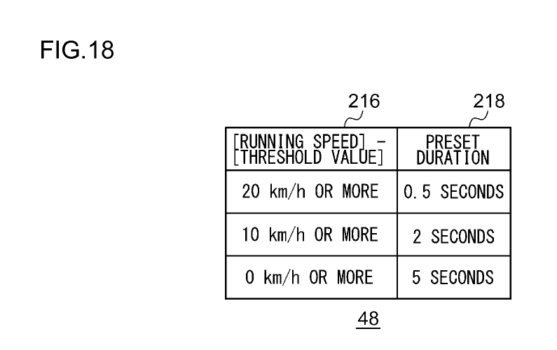

When the running velocity acquired by the acquiring unit 34 exceeds a threshold value, the threshold setting unit 46 of the alarming apparatus 10 changes the duration of a certain period of time according to a difference between the running velocity and the threshold value. FIG. 18 shows a data structure of a table stored in the comparison unit 48 according to the fifth exemplary embodiment of the present invention. As shown in FIG. 18, a running-velocity-minus-threshold-value column 216 and a preset-duration column 218 are contained in the table. When the running velocity exceeds the threshold value, the threshold setting unit 46 references the table and thereby sets a certain period of time (preset duration). If, for example, the running velocity is higher than the threshold value by 15 km/h, the threshold setting unit 46 will set two seconds as the preset duration. If the difference between the running velocity and the threshold changes after the preset duration has been set and if the preset duration is anticipated to become shorter, the threshold setting unit 46 will change the current preset duration.

Assume, for example, that the preset duration is first set to two seconds and then the difference between the running velocity and the threshold value changes to 5 km/h before the present duration of two seconds elapses. Then the threshold setting unit 46 will keep the preset duration at two seconds without changing the preset duration to five seconds. Assume, on the other hand, that the preset duration is first set to two seconds and then the difference between the running velocity and the threshold value changes to 25 km/h before the present duration of two seconds elapses. Then the threshold setting unit 46 will change the preset duration from two seconds to 0.5 seconds. As a result, if 0.5 seconds have already elapsed, the threshold setting unit 46 will immediately detect the excess state.

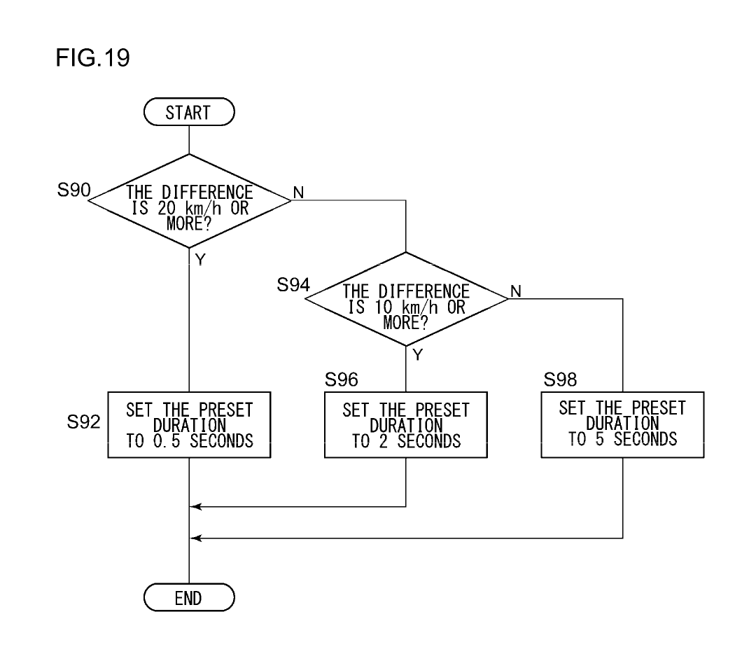

FIG. 19 is a flowchart showing that a certain period of time (preset duration) is adjusted by an alarming apparatus 10 according to the fifth exemplary embodiment of the present invention. If the difference therebetween is equal to or greater than 20 km/h (Y of S90), the threshold setting unit 46 will set the preset duration to 0.5 seconds (S92). If the difference is not 20 km/h or more (No of S90) but is equal to or greater than 10 km/h (Y of S94), the threshold setting unit 46 will set the preset duration to two seconds (S96). If the difference is not 10 km/h or more (No of S94), the threshold setting unit 46 will set the preset duration to five seconds (S98).

By employing the fifth exemplary embodiment, a preset duration suited to the difference therebetween is set. Thus, the period until when the warning is outputted can be adjusted according to the running velocity. Also, the preset duration is shortened as the difference becomes greater, so that the period until the warning is outputted can be reduced. Also, since the period until when the warning is outputted is reduced, the pedestrians can be alerted instantly.

The present invention has been described based on the exemplary embodiments. The exemplary embodiments are intended to be illustrative only, and it is understood by those skilled in the art that various modifications to constituting elements or an arbitrary combination of each process could be further developed and that such modifications are also within the scope of the present invention.

In the second to fourth exemplary embodiments, the output unit 38 changes the volume of sound, the light intensity and the output power when the threshold value has been changed. However, this should not be considered as limiting and, for example, the output unit 38 may not change the volume of sound, the light intensity and the output power when the threshold value has been changed. According to this modification, the processing can be simplified.

In the third exemplary embodiment, the clocking unit 52 is included in the alarming apparatus 10. However, this should not be considered as limiting and, for example, the clocking unit 52 may not be included at all. According to this modification, the threshold value can be changed depending on the area or areas only.

What is claimed is:

1. An alarming apparatus mountable on a vehicle, comprising:
an acquiring unit configured to acquire a running velocity of the vehicle;
a control unit configured to detect an excess status where the running velocity acquired by the acquiring unit exceeds a threshold value, which is higher than a speed limit set for a road on which the vehicle runs, for a predetermined duration of time; and
an output unit configured to output a warning to a pedestrian, when the control unit has detected the excess status.

2. An alarming apparatus according to claim 1, wherein the control unit varies the threshold value depending on a time zone.

3. An alarming apparatus according to claim 1, wherein the control unit varies the threshold value depending on an area that contains the road on which the vehicle runs.

4. An alarming apparatus according to claim 1, wherein the control unit varies the threshold value depending on weather.

5. An alarming apparatus according to claim 1, wherein, when the running velocity acquired by the acquiring unit exceeds the threshold value, which is higher than the speed limit set for the road on which the vehicle runs, the control unit varies the predetermined duration of time depending on a difference between the running velocity and the threshold value.

6. An alarming apparatus according to claim 1, wherein the output unit outputs sound or light as an output of the warning.

7. An alarming apparatus according to claim 1, wherein the output unit transmits a radio signal as an output of the warning.

8. An alarming apparatus according to claim 2, wherein the output unit outputs sound or light as an output of the warning, and the output unit varies a sound volume or light intensity in response to the threshold value.

9. An alarming apparatus according to claim 2, wherein the output unit transmits a radio signal as an output of the warning, and the output unit varies a transmission power in response to the threshold value.

10. A terminal apparatus carriable by a pedestrian, comprising:
a receiver configured to receive a radio signal, which is transmitted from an alarming apparatus mountable on a vehicle, when a running velocity of the vehicle exceeds a threshold value, which is higher than a speed limit set for a road on which the vehicle runs, for a predetermined duration of time; and
a notification unit configured to convey a warning to a pedestrian, when the receiver has received the radio signal.

11. An alarming apparatus in an alarming system that includes an alarming apparatus mountable on a vehicle and a terminal apparatus carriable by a pedestrian, the alarming apparatus comprising:
an acquiring unit configured to acquire a running velocity of the vehicle;
a control unit configured to detect an excess status where the running velocity acquired by the acquiring unit exceeds a threshold value, which is higher than a speed limit set for a road on which the vehicle runs, for a predetermined duration of time; and
an output unit configured to transmit a radio signal, when the control unit has detected the excess status.

12. A terminal apparatus in an alarming system that includes an alarming apparatus mountable on a vehicle and a terminal apparatus carriable by a pedestrian, the terminal apparatus comprising:
a receiver configured to receive a radio signal, which is transmitted from the alarming apparatus, when a running velocity of the vehicle exceeds a threshold value, which is higher than a speed limit set for a road on which the vehicle runs, for a predetermined duration of time; and
a notification unit configured to convey a warning to a pedestrian, when the receiver has received the radio signal.

13. An alarming system comprising:
an alarming apparatus mountable on a vehicle; and
a terminal apparatus carriable by a pedestrian,
wherein, when a running velocity of the vehicle exceeds a threshold value, which is higher than a speed limit set for a road on which the vehicle runs, for a predetermined duration of time, the alarming apparatus transmits a radio signal, and
wherein, when the terminal apparatus receives the radio signal from the alarming apparatus, the terminal apparatus conveys a warning to a pedestrian.

14. A method for outputting a warning in an alarming apparatus mountable on a vehicle, the method comprising:
acquiring a running velocity of the vehicle;
detecting an excess status where the running velocity acquired exceeds a threshold value, which is higher than a speed limit set for a road on which the vehicle runs, for a predetermined duration of time; and
outputting a warning to a pedestrian, when the excess status is detected.

15. A method of notification in a terminal apparatus carriable by a pedestrian, the method comprising:
receiving a radio signal, which is transmitted from an alarming apparatus mountable on a vehicle, when a running velocity of the vehicle exceeds a threshold value, which is higher than a speed limit set for a road on which the vehicle runs, for a predetermined duration of time; and
conveying a warning to the pedestrian, when the radio signal is received.
